(19) United States
(12) Patent Application Publication
(10) Pub. No.: US 2026/0270499 A1
(43) Pub. Date: Sep. 10, 2026

(54) METHOD AND TUNER CONTROLLER FOR CLOSED-LOOP ANTENNA TUNING BASED ON CALIBRATION DATA AND RELATIVE TRANSDUCER GAIN MAXIMIZATION

(71) Applicant: MEDIATEK INC., Hsinchu City (TW)

(72) Inventors: Chun-Hsiang Chen, Hsinchu City (TW); Po-Chung Hsiao, Hsinchu City (TW); Yen-Liang Chen, Hsinchu City (TW); Ting-Ju Yeh, Hsinchu City (TW)

(73) Assignee: MEDIATEK INC., Hsinchu City (TW)

(21) Appl. No.: 19/533,341

(22) Filed: Feb. 9, 2026

Related U.S. Application Data
(60) Provisional application No. 63/767,643, filed on Mar. 6, 2025.

(51) Int. Cl. H04N 21/426; H04B 1/04; H04B 1/18; H04N 5/50; H04N 21/438

(52) U.S. Cl. CPC H04N 21/4263; H04B 1/0458; H04B 1/18; H04N 5/50; H04N 21/4383

(57) ABSTRACT

A method for performing closed-loop antenna tuning includes initializing a tuner codeword with an initial codeword; setting a tuner based on the tuner codeword; acquiring a forward signal and a reverse signal associated with a radio frequency front-end; calculating a feedback-receiver reflection value based on the forward signal and the reverse signal; estimating an antenna reflection value by applying the feedback-receiver reflection value and calibration data to an estimation function, wherein the calibration data includes S-parameters of the radio frequency front-end and S-parameters of the tuner corresponding to tuner codewords; sweeping a plurality of candidate codewords to evaluate a relative transducer gain for each of the plurality of candidate codewords based on the estimated antenna reflection value and the calibration data; selecting a best codeword by maximizing the relative transducer gain; and updating the tuner codeword based on the best codeword.

### CROSS REFERENCE TO RELATED APPLICATIONS

This application claims the benefit of U.S. Provisional Application No. 63/767,643, filed on Mar. 6, 2025. The content of the application is incorporated herein by reference.

### BACKGROUND

Wireless devices used in daily life, such as smartphones and other user equipment, can operate under usage conditions that vary over time. Changes in proximity to a user, device handling, or surrounding objects can affect antenna impedance and increase signal reflection, which can degrade radio frequency transmission performance.

To address such variations, some systems adjust a tuner setting of a tuner based on feedback signals associated with a radio frequency front-end, and some systems can further utilize calibration information obtained in advance.

However, a tuner setting selected under one condition can become sub-optimal under another condition, and estimation accuracy can vary with a tuner setting and operating scenario. Accordingly, providing a method or a system that can improve the robustness of tuner setting selection based on feedback signals and calibration information remains an important design issue for antenna tuning in practical daily-life environments.

### SUMMARY

In one embodiment, a method for performing closed-loop antenna tuning is disclosed. The method comprises initializing a tuner codeword with an initial codeword; setting a tuner based on the tuner codeword; acquiring a forward signal and a reverse signal associated with a radio frequency front-end; calculating a feedback-receiver reflection value based on the forward signal and the reverse signal; estimating an antenna reflection value by applying the feedback-receiver reflection value and calibration data to an estimation function, wherein the calibration data comprises S-parameters of the radio frequency front-end and S-parameters of the tuner corresponding to tuner codewords; sweeping a plurality of candidate codewords to evaluate a relative transducer gain for each of the plurality of candidate codewords based on the estimated antenna reflection value and the calibration data; selecting a best codeword from the plurality of candidate codewords by maximizing the relative transducer gain; and updating the tuner codeword based on the best codeword.

In one embodiment, a tuner controller for performing closed-loop antenna tuning is disclosed. The tuner controller comprises a processor and a memory coupled to the processor and storing calibration data. The processor is configured to initialize a tuner codeword with an initial codeword; set a tuner based on the tuner codeword; acquire a forward signal and a reverse signal associated with a radio frequency front-end; calculate a feedback-receiver reflection value based on the forward signal and the reverse signal; estimate an antenna reflection value by applying the feedback-receiver reflection value and the calibration data to an estimation function, wherein the calibration data comprises S-parameters of the radio frequency front-end and S-parameters of the tuner corresponding to tuner codewords; sweep a plurality of candidate codewords to evaluate a relative transducer gain for each of the plurality of candidate codewords based on the estimated antenna reflection value and the calibration data; select a best codeword from the plurality of candidate codewords by maximizing the relative transducer gain; and update the tuner codeword based on the best codeword.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic block diagram of an antenna system according to an embodiment of the present invention.

FIG. 2 is a flowchart illustrating a procedure for selecting a best codeword for antenna tuning based on a feedback-receiver reflection value and calibration data.

FIG. 3 is a schematic diagram illustrating an i-th iteration for selecting a best codeword and updating a tuner codeword for a subsequent iteration.

FIG. 4 is a schematic diagram illustrating an iterative closed-loop antenna tuning procedure across a plurality of iterations.

FIG. 5 is a flowchart illustrating an embodiment of an infinite-iteration procedure for closed-loop antenna tuning.

FIG. 6 is a flowchart illustrating an embodiment of a fixed-iteration-count procedure for closed-loop antenna tuning.

FIG. 7 is a flowchart illustrating an embodiment of an early-stopping procedure for closed-loop antenna tuning.

FIG. 8 is a flowchart of a method for performing closed-loop antenna tuning of a tuner controller of the antenna system in FIG. 1.

### DETAILED DESCRIPTION

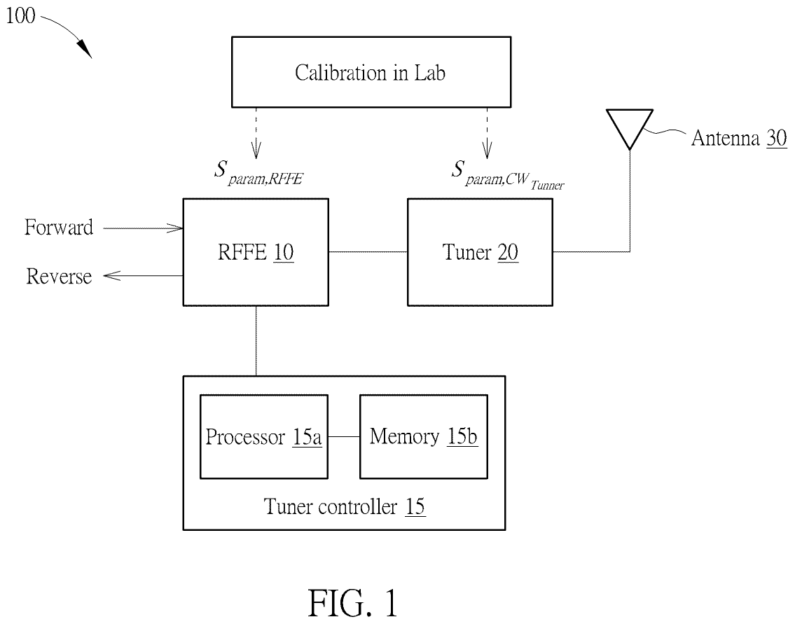

FIG. 1 is a schematic block diagram of an antenna system according to an embodiment of the present invention. As shown in FIG. 1, an antenna system 100 includes a radio frequency front-end (RFFE) 10, a tuner 20, an antenna 30, and a tuner controller 15. The tuner controller 15 includes a processor 15a and a memory 15b, and the memory 15b is coupled to the processor 15a. The RFFE 10 is coupled to the tuner 20, the tuner 20 is coupled to the antenna 30, and the tuner controller 15 is coupled to the RFFE 10 and is configured to control the tuner 20. The antenna system 100 performs closed-loop antenna tuning by acquiring a forward signal and a reverse signal associated with reflection, estimating an antenna reflection value based on calibration data, and updating a tuner codeword used to set the tuner 20. The described computations are tied to physical signals and to a physical tuning network through the forward signal, the reverse signal, and control of the tuner 20.

The RFFE 10 includes circuitry for radio-frequency transmission and circuitry for acquiring feedback associated with reflection. The RFFE 10 is associated with the forward signal and the reverse signal. The forward signal represents a signal component propagating from the RFFE 10 toward the antenna 30 through an antenna path including the tuner 20. The reverse signal represents a signal component propagating back toward the RFFE 10 due to reflection associated with an impedance presented by the antenna path. The forward signal and the reverse signal can be acquired using a directional coupler, a detector, a feedback receiver path, or a combination thereof. The forward signal and the reverse signal can be provided to the tuner controller 15 as digital samples, digital words, analog voltages, or a combination thereof, depending on an implementation of the RFFE 10 and an interface between the RFFE 10 and the tuner controller 15. The RFFE 10 can include, for example, a power amplifier, a switching network, a coupler, a detector, and an analog-to-digital converter.

The tuner 20 is a hardware tuning network having discrete settings controlled by a tuner codeword. The tuner codeword represents a configuration state of internal components of the tuner 20. The internal components include switching elements and reactive components, and a particular combination of switch states corresponds to a particular tuner codeword. The reactive components include capacitors, inductors, or a combination thereof. The tuner 20 can be implemented by a switched-capacitor network, a switched-inductor network, a switched impedance network, a tunable matching network, or a combination thereof. The tuner controller 15 sets the tuner 20 based on the tuner codeword by transmitting the tuner codeword to the tuner 20 through a control interface, such as a serial interface, a parallel interface, or a control bus. After the tuner 20 is set based on the tuner codeword, the tuner 20 presents a corresponding impedance to the antenna path to influence reflection behavior observed at the RFFE 10.

The tuner controller 15 performs computation and control for closed-loop antenna tuning. The processor 15a is configured to initialize the tuner codeword with an initial codeword and to set the tuner 20 based on the tuner codeword. The processor 15a is further configured to acquire the forward signal and the reverse signal associated with the RFFE 10 and to calculate a feedback-receiver reflection value based on the forward signal and the reverse signal. The feedback-receiver reflection value represents a reflection-related quantity derived at a feedback observation point associated with the RFFE 10. The feedback-receiver reflection value can be derived based on a relationship between the reverse signal and the forward signal, and the relationship can be represented using magnitude information, phase information, complex samples, or a combination thereof.

The memory 15b stores calibration data, and the calibration data is acquired in a calibration stage performed in a lab, as represented by “Calibration in Lab” in FIG. 1. The calibration data includes S-parameters of the RFFE 10 and S-parameters of the tuner 20 corresponding to tuner codewords. The processor 15a estimates an antenna reflection value by applying the feedback-receiver reflection value and the calibration data to an estimation function. The processor 15a acquires the calibration data from the memory 15b for executing the estimation function. The estimation function is stored as instructions, coefficients, or both in the memory 15b and is executed by the processor 15a. The estimation function can be implemented as a network transformation based on S-parameters, a model-based mapping between the feedback-receiver reflection value and the antenna reflection value, a calibration-table based mapping derived from the calibration stage performed in a lab, or a combination thereof.

The memory 15b can further store a plurality of candidate codewords for sweeping. The processor 15a sweeps the plurality of candidate codewords to evaluate a relative transducer gain for each of the plurality of candidate codewords based on the estimated antenna reflection value and the calibration data. For each candidate codeword, the processor 15a applies calibration data corresponding to the candidate codeword and generates a relative transducer gain value associated with the candidate codeword. The processor 15a selects a best codeword from the plurality of candidate codewords by maximizing the relative transducer gain. The processor 15a updates the tuner codeword based on the best codeword so that the tuner 20 can be set based on the updated tuner codeword in a subsequent operation.

The tuner controller 15 initializes the tuner codeword with the initial codeword. The initial codeword can be a fixed initial codeword stored in the memory 15b. The memory 15b can further store a plurality of candidate initial codewords, and the processor 15a can select the initial codeword from the plurality of candidate initial codewords based on a detected use scenario. The detected use scenario represents a usage condition associated with the antenna system 100. The detected use scenario can be determined based on sensor information, device state information, radio configuration information, or a combination thereof. After selecting the initial codeword, the processor 15a initializes the tuner codeword with the selected initial codeword.

The processor 15a can be implemented by a microprocessor, a digital signal processor, a microcontroller, programmable logic, an application-specific integrated circuit, or a combination thereof. The memory 15b can be implemented by non-volatile memory, volatile memory, or a combination thereof. The tuner controller 15 can be integrated with the RFFE 10 or implemented as circuitry separate from the RFFE 10. Details of performing closed-loop antenna tuning are illustrated below.

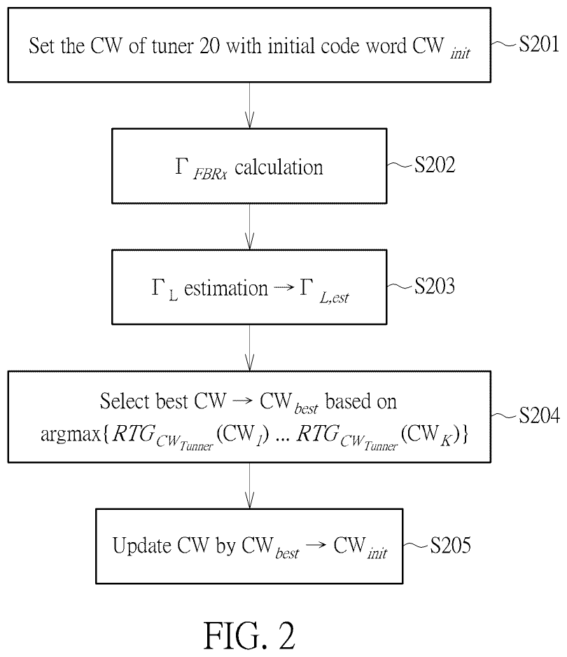

FIG. 2 is a flowchart illustrating a procedure for selecting a best codeword for antenna tuning based on a feedback-receiver reflection value and calibration data. As shown in FIG. 2, the procedure includes steps S201 to S205 and is performed by the tuner controller 15 of the antenna system 100 in FIG. 1. In the procedure, the tuner controller 15 sets the tuner 20 with an initial codeword CWᵢₙᵢₜ, derives a feedback-receiver reflection value Γ_{FBRx} from a forward signal and a reverse signal associated with the RFFE 10, estimates an antenna reflection value Γ_{L,est} by applying Γ_{FBRx} and calibration data to an estimation function, selects a best codeword CW_{best} by maximizing a relative transducer gain across candidate codewords, and updates the codeword used for subsequent operation.

For clarity of terminology in the following descriptions, CWᵢₙᵢₜ denotes an initial codeword used to initialize a tuner codeword for setting the tuner 20. CW_{Tuner} denotes a current tuner codeword used to set the tuner 20 in a current iteration. CWᵢₜₑᵣ_{ᵢ} denotes a tuner codeword used as CW_{Tuner} in an i-th iteration. In the i-th iteration, the tuner controller 15 selects a best codeword denoted as CW_{best,iter}_{ᵢ} by maximizing a relative transducer gain across candidate codewords, and the tuner controller 15 updates the tuner codeword to a subsequent tuner codeword CWᵢₜₑᵣ_{ᵢ₊₁} based on CW_{best,iter}_{ᵢ} after the selection is completed. After the update of the i-th iteration is completed, CWᵢₜₑᵣ_{ᵢ₊₁} is used as CW_{Tuner} for setting the tuner 20 in a subsequent iteration.

At step S201, the tuner controller 15 sets the codeword of the tuner 20 with the initial codeword CWᵢₙᵢₜ. The initial codeword CWᵢₙᵢₜ represents a control state of the tuner 20. The tuner 20 is a hardware tuning network having discrete settings controlled by a tuner codeword, and the tuner controller 15 sets the tuner 20 by transmitting the tuner codeword to the tuner 20 through a control interface. The initial codeword CWᵢₙᵢₜ can be a fixed codeword stored in the memory 15b. The initial codeword CWᵢₙᵢₜ can also be selected from a plurality of candidate initial codewords stored in the memory 15b based on a detected use scenario. The detected use scenario can be determined based on available sensor information, device state information, radio configuration information, or a combination thereof. After the tuner 20 is set with CWᵢₙᵢₜ, the antenna system 100 operates with an impedance corresponding to CWᵢₙᵢₜ, and the forward signal and the reverse signal acquired in subsequent steps correspond to the tuner 20 being set with CWᵢₙᵢₜ.

At step S202, the tuner controller 15 performs a Γ_{FBRx} calculation. The tuner controller 15 acquires the forward signal and the reverse signal associated with the RFFE 10 and calculates the feedback-receiver reflection value Γ_{FBRx} based on the forward signal and the reverse signal. The forward signal and the reverse signal can be acquired using a directional coupler, a detector, a feedback receiver path, or a combination thereof. The tuner controller 15 can receive the forward signal and the reverse signal. The tuner controller 15 then derives Γ_{FBRx} based on a relationship between the forward signal and the reverse signal. The feedback-receiver reflection value Γ_{FBRx} represents a reflection-related quantity at a feedback observation point associated with the RFFE 10 under the tuner 20 being set with CWᵢₙᵢₜ.

At step S203, the tuner controller 15 performs a Γ_{L} estimation to generate an estimated antenna reflection value Γ_{L,est}. The tuner controller 15 applies the feedback-receiver reflection value Γ_{FBRx} and calibration data to an estimation function to produce Γ_{L,est}. The calibration data is stored in the memory 15b and includes S-parameters of the RFFE 10 and S-parameters of the tuner 20 corresponding to tuner codewords. The calibration data is acquired in advance, such as in a calibration stage performed in a lab, and the tuner controller 15 acquires the calibration data from the memory 15b when executing the estimation function.

The estimation function is stored as instructions, coefficients, or both in the memory 15b and is executed by the processor 15a. The estimation function can be implemented as a network transformation based on S-parameters, a model-based mapping between Γ_{FBRx} and an antenna-side reflection value, a calibration-table based mapping derived from calibration results, or a combination thereof. The estimated antenna reflection value Γ_{L,est} represents a reflection-related quantity associated with a load side that includes the tuner 20 and the antenna 30.

At step S204, the tuner controller 15 selects a best codeword CW_{best} based on an argmax{ } operation over a plurality of candidate codewords. The tuner controller 15 sweeps candidate codewords CW₁ to CW_{K} and evaluates a relative transducer gain for each candidate codeword based on Γ_{L,est} and the calibration data. The relative transducer gain is evaluated for each candidate codeword using calibration data corresponding to that candidate codeword. The selection in FIG. 2 can be expressed as:

$${CW}_{best} = arg {max}_{{CW}_{k} ∈ \{ {CW}_{1} , … {CW}_{K} \}} {RTG}_{{CW}_{Tuner}} ( {CW}_{k} )$$

where RTG_{CW}_{_{Tuner}}(CWₖ) denotes a relative transducer gain value evaluated for candidate codeword CWₖ under the estimated antenna reflection value Γ_{L,est} and the calibration data. The tuner controller 15 compares the evaluated relative transducer gain values and selects the codeword that yields the maximum value as CW_{best}.

At step S205, the tuner controller 15 updates CW_{Tuner} based on CW_{best} by setting CW_{Tuner} to CW_{best}, where CW_{Tuner} is initialized as CWᵢₙᵢₜ, such that the tuner 20 is subsequently set based on the updated CW_{Tuner}.

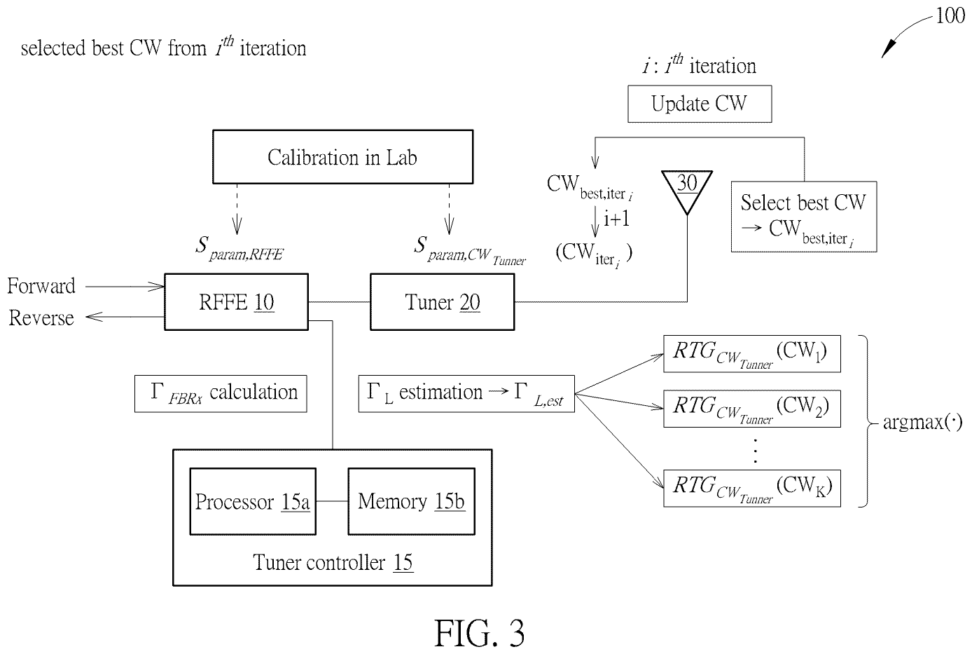

FIG. 3 is a schematic diagram illustrating an i-th iteration for selecting a best codeword and updating a tuner codeword for a subsequent iteration.

As shown in FIG. 3, the antenna system 100 performs an i-th iteration of a closed-loop antenna tuning procedure by using the tuner controller 15 to select a best codeword and to update a tuner codeword for a subsequent iteration. In the i-th iteration, the tuner controller 15 uses a tuner codeword CWᵢₜₑᵣ_{ᵢ} as a current codeword for setting the tuner 20, and the tuner controller 15 updates the tuner codeword to a subsequent tuner codeword CWᵢₜₑᵣ_{ᵢ} based on a best codeword selected in the i-th iteration. The tuner controller 15 includes the processor 15a and the memory 15b. The memory 15b stores calibration data acquired in advance in a lab and provides the calibration data to the processor 15a during the i-th iteration. The calibration data includes S-parameters of the RFFE 10, denoted as S_{param,RFFE}, and S-parameters of the tuner 20 corresponding to tuner codewords, denoted as S_{param,CW}_{_{Tuner}}(⋅).

During the i-th iteration, the tuner controller 15 sets the tuner 20 based on the current tuner codeword CWᵢₜₑᵣ_{ᵢ}. While the tuner 20 is set based on CWᵢₜₑᵣ_{ᵢ}, the RFFE 10 provides a forward signal and a reverse signal associated with an antenna path that includes the tuner 20 and the antenna 30. The tuner controller 15 calculates a feedback-receiver reflection value Γ_{FBRx} based on the forward signal and the reverse signal. The tuner controller 15 estimates an antenna reflection value Γ_{L,est} by applying Γ_{FBRx} and the calibration data to an estimation function. Details of calculating Γ_{FBRx} and estimating Γ_{L,est} have been previously described with reference to FIG. 2, and therefore are not repeated herein.

After obtaining Γ_{L,est} in the i-th iteration, the tuner controller 15 evaluates a relative transducer gain for each candidate codeword in a candidate codeword set. In FIG. 3, the candidate codeword set includes candidate codewords CW₁ to CW_{K}. For each candidate codeword CWR, the tuner controller 15 evaluates a relative transducer gain RTG_{CW}_{_{Tuner}}(CWₖ) based on Γ_{L,est} and the calibration data, where the calibration data includes S_{param,RFFE} and S_{param,CW}_{_{Tuner}}(CWₖ). The tuner controller 15 then selects a best codeword for the i-th iteration by maximizing the relative transducer gain across the candidate codewords. The selection can be expressed as:

$${CW}_{best , {iter}_{i}} = arg {max}_{{CW}_{k} ∈ \{ {CW}_{1} , … {CW}_{K} \}} {RTG}_{{CW}_{Tuner}} ( {CW}_{k} )$$

where CW_{best,iter}_{ᵢ} denotes a best codeword selected in the i-th iteration. The tuner controller 15 updates the tuner codeword for the subsequent iteration based on the selected best codeword CW_{best,iter}_{ᵢ}. In FIG. 3, the update operation is illustrated as an “Update CW” operation that generates a subsequent tuner codeword CWᵢₜₑᵣ_{ᵢ₊₁} for a subsequent iteration. The update can be expressed as a setting:

$${CW}_{{iter}_{i + 1}} ← {CW}_{best , {iter}_{i}}$$

Accordingly, the tuner codeword used to set the tuner 20 in a subsequent iteration is updated to reflect the best codeword selected in the i-th iteration, and the subsequent iteration uses the updated tuner codeword CWᵢₜₑᵣ_{ᵢ₊₁} as the current tuner codeword for setting the tuner 20.

The i-th iteration shown in FIG. 3 generalizes a single selection-and-update cycle into an indexed iteration framework. The tuner controller 15 repeatedly ties calculation results derived from the forward signal and the reverse signal to a physical tuner setting by selecting a best codeword and updating the tuner codeword for a subsequent iteration, thereby maintaining a closed-loop tuning procedure that is grounded in measured signals and control of the tuner 20.

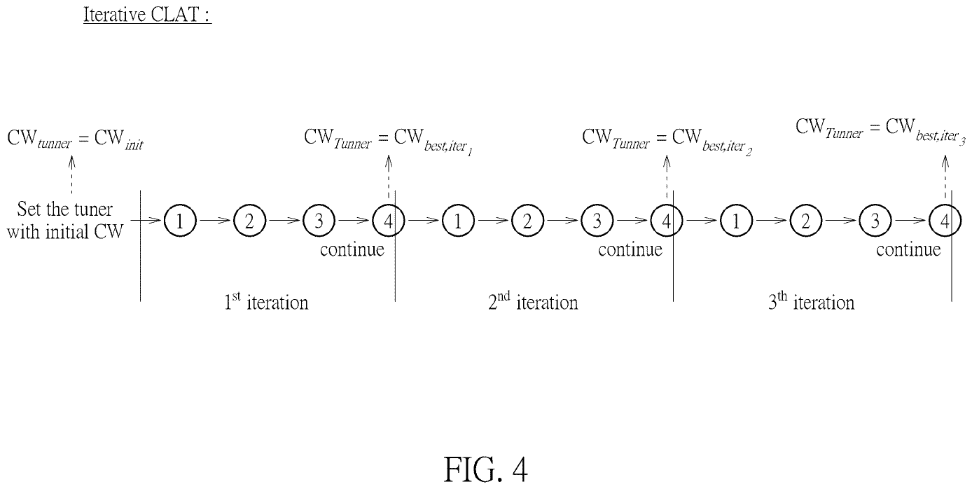

FIG. 4 is a schematic diagram illustrating an iterative closed-loop antenna tuning procedure across a plurality of iterations.

As shown in FIG. 4, the antenna system 100 performs an iterative closed-loop antenna tuning procedure by repeatedly executing a same selection-and-update cycle, where the tuner controller 15 controls a tuner codeword CW_{Tuner} for setting the tuner 20. In FIG. 4, CW_{Tuner} is initialized as an initial codeword CWᵢₙᵢₜ before a first iteration starts. The first iteration then executes steps (1 to 4) as a selection-and-update cycle. After all steps of the first iteration are completed, CW_{Tuner} is updated to a best codeword selected in the first iteration, denoted as CW_{best,iter}_{₁} and the tuner 20 is subsequently set based on the updated CW_{Tuner}.

A second iteration is then executed using the updated CW_{Tuner}, and steps of the second iteration are performed in the same manner. After all steps of the second iteration are completed, CW_{Tuner} is updated to a best codeword selected in the second iteration, denoted as CW_{best,iter}_{₂}. A third iteration is executed using the updated CW_{Tuner}, and after all steps of the third iteration are completed, CW_{Tuner} is updated to a best codeword selected in the third iteration, denoted as CW_{best,iter}_{₃}. The iterative closed-loop antenna tuning procedure continues across additional iterations by repeating the same selection-and-update cycle and by updating CW_{Tuner} after completion of steps in each iteration, and the updated CW_{Tuner} is used for setting the tuner 20 in a subsequent iteration.

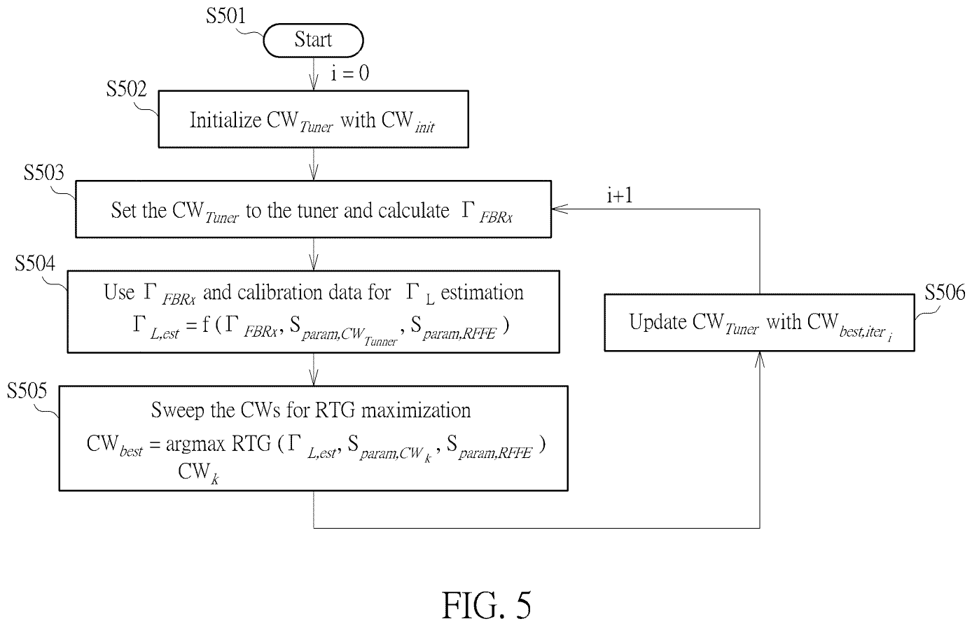

FIG. 5 is a flowchart illustrating an embodiment of an infinite-iteration procedure for closed-loop antenna tuning. As shown in FIG. 5, steps S501 to S506 are performed by the tuner controller 15 of the antenna system 100 in FIG. 1, and the tuner controller 15 repeatedly executes a selection-and-update cycle without terminating based on an iteration count and without terminating based on a stopping criterion. In FIG. 5, an iteration index i is initialized as i=0 at step S501, and the iteration index i is incremented as the procedure continues.

At step S502, the tuner controller 15 initializes a tuner codeword CW_{Tuner} with an initial codeword CWᵢₙᵢₜ. The initial codeword CWᵢₙᵢₜ represents an initial control state for setting the tuner 20. The initial codeword CWᵢₙᵢₜ can be acquired from the memory 15b as a fixed codeword, and the initial codeword CWᵢₙᵢₜ can also be selected from a plurality of candidate initial codewords stored in the memory 15b based on a detected use scenario, as previously described.

At step S503, the tuner controller 15 sets the tuner 20 based on the tuner codeword CW_{Tuner} and calculates a feedback-receiver reflection value Γ_{FBRx}. In this step, while the tuner 20 is set based on CW_{Tuner}, the tuner controller 15 acquires a forward signal and a reverse signal associated with the RFFE 10 and derives Γ_{FBRx} based on the forward signal and the reverse signal, as previously described.

At step S504, the tuner controller 15 estimates an antenna reflection value (e.g., estimated antenna reflection value) Γ_{L,est} by applying the feedback-receiver reflection value Γ_{FBRx} and calibration data to an estimation function. In FIG. 5, the estimation can be expressed as:

$${Γ}_{L , est} = f ( {Γ}_{FBRx} , {S}_{param , {CW}_{Tuner}} , {S}_{param , RFFE} )$$

where S_{param,RFFE} denotes S-parameters of the RFFE 10, and S_{param,CW}_{_{Tuner}} denotes S-parameters of the tuner 20 corresponding to the tuner codeword CW_{Tuner}. The calibration data is stored in the memory 15b and is acquired in advance, such as in a calibration stage performed in a lab, and the tuner controller 15 acquires the calibration data from the memory 15b when executing the estimation function.

At step S505, the tuner controller 15 sweeps a plurality of candidate codewords for relative transducer gain maximization and selects a best codeword in a current iteration. In FIG. 5, the selection can be expressed as:

$${CW}_{best} = arg {max}_{{CW}_{k} ∈ \{ {CW}_{1} , … {CW}_{K} \}} RTG ( {Γ}_{L , est} {S}_{param , {CW}_{k}} , {S}_{param , RFFE} )$$

where CWₖ denotes a candidate codeword in a candidate codeword set, S_{param,CW}_{ₖ} denotes S-parameters of the tuner 20 corresponding to the candidate codeword CWₖ, and RTG(⋅) denotes a relative transducer gain evaluated based on Γ_{L,est} and calibration data. The tuner controller 15 compares evaluated relative transducer gain values across candidate codewords and selects the candidate codeword yielding a maximum relative transducer gain value as the best codeword of the current iteration.

At step S506, the tuner controller 15 updates the tuner codeword CW_{Tuner} with a best codeword selected in the current iteration, denoted as CW_{best,iter}_{ᵢ}, and the procedure continues to a subsequent iteration. After the update at step S506, the tuner codeword CW_{Tuner} used in a subsequent iteration is updated to reflect the best codeword selected in the preceding iteration. The tuner controller 15 then increments the iteration index from i to i+1 and returns to step S503 so that the tuner 20 is set based on the updated CW_{Tuner}, and the same cycle of calculating Γ_{FBRx}, estimating Γ_{L,est}, sweeping candidate codewords for relative transducer gain maximization, and updating CW_{Tuner} is repeatedly executed for subsequent iterations.

The infinite-iteration procedure in FIG. 5 maintains a continuous iterative closed-loop antenna tuning behavior by repeatedly updating the tuner codeword based on a best codeword selected in each iteration, without applying a termination condition based on a predefined maximum iteration count and without applying a termination condition based on a stopping criterion. Details of calculating Γ_{FBRx}, estimating Γ_{L,est}, and selecting the best codeword by maximizing relative transducer gain have been previously described with reference to FIG. 2 and FIG. 3, and therefore are not repeated herein.

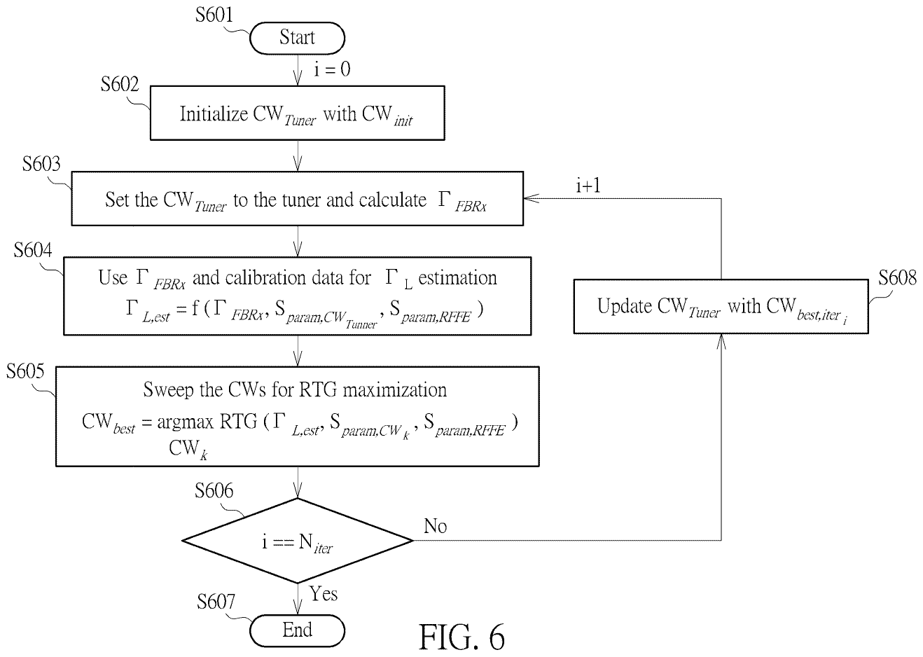

FIG. 6 is a flowchart illustrating an embodiment of a fixed-iteration-count procedure for closed-loop antenna tuning. As shown in FIG. 6, steps S601 to S608 are performed by the tuner controller 15 of the antenna system 100 in FIG. 1. The fixed-iteration-count procedure repeats a selection-and-update cycle across iterations while maintaining an iteration index i, and the fixed-iteration-count procedure terminates when the iteration index i reaches a predefined maximum iteration count Nᵢₜₑᵣ. The predefined maximum iteration count Nᵢₜₑᵣ can be stored in the memory 15b, configured as a parameter of the tuner controller 15, or provided by higher-layer control logic associated with the antenna system 100.

At step S601, the tuner controller 15 starts the fixed-iteration-count procedure by initializing the iteration index i as i=0. The iteration index i represents a current iteration number used to control termination of the repetition based on the predefined maximum iteration count Nᵢₜₑᵣ.

At step S602, the tuner controller 15 initializes a tuner codeword CW_{Tuner} with an initial codeword CWᵢₙᵢₜ. The initial codeword CWᵢₙᵢₜ represents an initial control state for setting the tuner 20. The initial codeword CWᵢₙᵢₜ can be acquired from the memory 15b as a fixed codeword, and the initial codeword CWᵢₙᵢₜ can also be selected from a plurality of candidate initial codewords stored in the memory 15b based on a detected use scenario, as previously described. After step S602, CW_{Tuner} is equal to CWᵢₙᵢₜ at an entry of an iteration controlled by the iteration index i.

At step S603, the tuner controller 15 sets the tuner 20 based on the tuner codeword CW_{Tuner} and calculates a feedback-receiver reflection value Γ_{FBRx}. In step S603, while the tuner 20 is set based on CW_{Tuner}, the tuner controller 15 acquires a forward signal and a reverse signal associated with the RFFE 10 and derives Γ_{FBRx} based on the forward signal and the reverse signal, as previously described. The forward signal and the reverse signal correspond to a physical antenna path that includes the tuner 20 and the antenna 30, and Γ_{FBRx} represents a reflection-related quantity derived at a feedback observation point associated with the RFFE 10.

At step S604, the tuner controller 15 estimates an antenna reflection value (e.g., an estimated antenna reflection value) Γ_{L,est} by applying the feedback-receiver reflection value Γ_{FBRx} and calibration data to an estimation function. In FIG. 6, the estimation can be expressed as:

$${Γ}_{L , est} = f ( {Γ}_{FBRx} , {S}_{param , {CW}_{Tuner}} , {S}_{param , RFFE} )$$

where S_{param,RFFE} denotes S-parameters of the RFFE 10 and S_{param,CW}_{_{Tuner}} denotes S-parameters of the tuner 20 corresponding to the tuner codeword CW_{Tuner}. The calibration data is stored in the memory 15b and is acquired in advance, such as in a calibration stage performed in a lab, and the tuner controller 15 acquires the calibration data from the memory 15b when executing the estimation function, as previously described.

At step S605, the tuner controller 15 sweeps a plurality of candidate codewords for relative transducer gain maximization and selects a best codeword in a current iteration. In FIG. 6, the selection can be expressed as:

$${CW}_{best} = arg {max}_{{CW}_{k} ∈ \{ {CW}_{1} , … {CW}_{K} \}} RTG ( {Γ}_{L , est ,} {S}_{param , {CW}_{k}} , {S}_{param , RFFE} )$$

where CWₖ denotes a candidate codeword in a candidate codeword set, S_{param,CW}_{ₖ} denotes S-parameters of the tuner 20 corresponding to the candidate codeword CWₖ, and RTG(⋅) denotes a relative transducer gain evaluated based on Γ_{L,est} and calibration data. The tuner controller 15 compares evaluated relative transducer gain values across candidate codewords and selects the candidate codeword yielding a maximum relative transducer gain value as the best codeword of the current iteration, as previously described.

At step S606, the tuner controller 15 determines whether the iteration index i is equal to the predefined maximum iteration count Nᵢₜₑᵣ. When the determination at step S606 indicates that i=Nᵢₜₑᵣ, the fixed-iteration-count procedure terminates at step S607. When the determination at step S606 indicates that i is not equal to Nᵢₜₑᵣ, the fixed-iteration-count procedure continues to step S608.

At step S608, the tuner controller 15 updates the tuner codeword CW_{Tuner} with a best codeword selected in the current iteration, denoted as CW_{best,iter}_{ᵢ}, and prepares to enter a subsequent iteration. After the update at step S608, the tuner codeword CW_{Tuner} used in the subsequent iteration reflects the best codeword selected in the preceding iteration. The tuner controller 15 increments the iteration index from i to i+1 and returns to step S603 so that the tuner 20 is set based on the updated CW_{Tuner} and the same cycle of calculating Γ_{FBRx}, estimating Γ_{L,est}, sweeping candidate codewords for relative transducer gain maximization, and updating CW_{Tuner} is repeatedly executed until the determination at step S606 indicates i=Nᵢₜₑᵣ.

The fixed-iteration-count procedure in FIG. 6 provides a bounded repeating behavior by terminating based on the predefined maximum iteration count Nᵢₜₑᵣ while maintaining the selection-and-update cycle grounded in acquiring the forward signal and the reverse signal associated with the RFFE 10 and in setting the tuner 20 based on the tuner codeword CW_{Tuner}, as previously described.

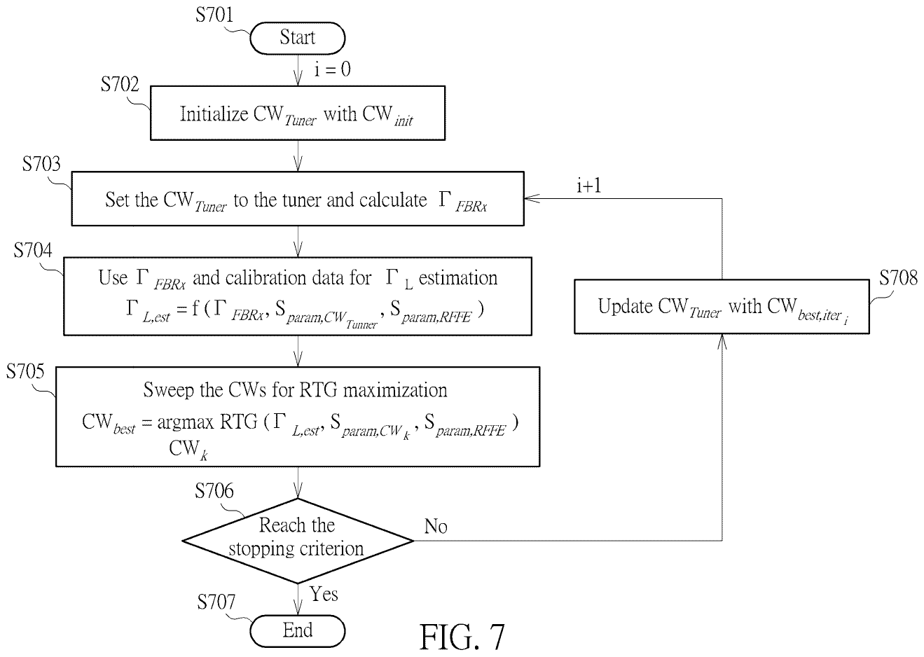

FIG. 7 is a flowchart illustrating an embodiment of an early-stopping procedure for closed-loop antenna tuning. As shown in FIG. 7, steps S701 to S708 are performed by the tuner controller 15 of the antenna system 100 in FIG. 1. The early-stopping procedure repeats a selection-and-update cycle across iterations while maintaining an iteration index i, and the early-stopping procedure terminates early in response to a stopping criterion being satisfied, instead of terminating only based on a predefined maximum iteration count.

At step S701, the tuner controller 15 starts the early-stopping procedure by initializing the iteration index i as i=0. The iteration index i represents a current iteration number used for tracking the repeating of the selection-and-update cycle.

At step S702, the tuner controller 15 initializes a tuner codeword CW_{Tuner} with an initial codeword CWᵢₙᵢₜ. The initial codeword CWᵢₙᵢₜ represents an initial control state for setting the tuner 20. The initial codeword CWᵢₙᵢₜ can be acquired from the memory 15b as a fixed codeword, and the initial codeword CWᵢₙᵢₜ can also be selected from a plurality of candidate initial codewords stored in the memory 15b based on a detected use scenario, as previously described.

At step S703, the tuner controller 15 sets the tuner 20 based on the tuner codeword CW_{Tuner} and calculates a feedback-receiver reflection value Γ_{FBRx}. In step S703, while the tuner 20 is set based on CW_{Tuner}, the tuner controller 15 acquires a forward signal and a reverse signal associated with the RFFE 10 and derives Γ_{FBRx} based on the forward signal and the reverse signal, as previously described.

At step S704, the tuner controller 15 estimates an antenna reflection value (e.g., an estimated antenna reflection value) Γ_{L,est} by applying the feedback-receiver reflection value Γ_{FBRx} and calibration data to an estimation function. In FIG. 7, the estimation can be expressed as:

$${Γ}_{L , est} = f ( {Γ}_{FBRx} , {S}_{param , {CW}_{Tuner}} , {S}_{param , RFFE} )$$

Where S_{param,RFFE} denotes S-parameters of the RFFE 10 and S_{param,CW}_{_{Tuner}} denotes S-parameters of the tuner 20 corresponding to the tuner codeword CW_{Tuner}. The calibration data is stored in the memory 15b and is acquired in advance, such as in a calibration stage performed in a lab, and the tuner controller 15 acquires the calibration data from the memory 15b when executing the estimation function, as previously described.

At step S705, the tuner controller 15 sweeps a plurality of candidate codewords for relative transducer gain maximization and selects a best codeword in a current iteration. In FIG. 7, the selection can be expressed as:

$${CW}_{best} = arg {max}_{{CW}_{k} ∈ \{ {CW}_{1} , … {CW}_{K} \}} RTG ( {Γ}_{L , est ,} {S}_{param , {CW}_{k}} , {S}_{param , RFFE} )$$

where CWₖ denotes a candidate codeword in a candidate codeword set, S_{param,CW}_{ₖ} denotes S-parameters of the tuner 20 corresponding to the candidate codeword CWR, and RTG(⋅) denotes a relative transducer gain evaluated based on Γ_{L,est} and calibration data, as previously described. The tuner controller 15 compares evaluated relative transducer gain values across candidate codewords and selects the candidate codeword yielding a maximum relative transducer gain value as the best codeword of the current iteration.

At step S706, the tuner controller 15 determines whether a stopping criterion is satisfied. The stopping criterion is satisfied in response to at least one of a plurality of early-stopping conditions being satisfied. In one condition, the stopping criterion is satisfied in response to the best codeword selected in the current iteration being identical to the tuner codeword CW_{Tuner} used for setting the tuner 20 in the current iteration. In another condition, the stopping criterion is satisfied in response to an improvement in the relative transducer gain between a preceding iteration and a current iteration being less than or equal to a predefined threshold.

For purposes of the early-stopping condition based on a relative transducer gain improvement, the tuner controller 15 defines the improvement in the relative transducer gain as a difference between a best relative transducer gain value of a current iteration and a best relative transducer gain value of a preceding iteration. The best relative transducer gain value of the current iteration is a maximum relative transducer gain value among relative transducer gain values evaluated for the plurality of candidate codewords in the current iteration, and the best relative transducer gain value of the preceding iteration is a maximum relative transducer gain value among relative transducer gain values evaluated for the plurality of candidate codewords in the preceding iteration. The tuner controller 15 determines that the early-stopping condition is satisfied in response to the difference being less than or equal to a predefined relative-transducer-gain-improvement threshold. The predefined relative-transducer-gain-improvement threshold can be stored in the memory 15b, configured as a parameter of the tuner controller 15, or provided by control logic of the antenna system 100, and the tuner controller 15 evaluates the difference and the predefined relative-transducer-gain-improvement threshold using a same representation.

When the determination at step S706 indicates that the stopping criterion is satisfied, the early-stopping procedure terminates at step S707.

When the determination at step S706 indicates that the stopping criterion is not satisfied, the early-stopping procedure continues to step S708. At step S708, the tuner controller 15 updates the tuner codeword CW_{Tuner} with a best codeword selected in the current iteration, denoted as CW_{best,iter}_{ᵢ}, and prepares to enter a subsequent iteration. After the update at step S708, the tuner codeword CW_{Tuner} used in the subsequent iteration reflects the best codeword selected in the preceding iteration. The tuner controller 15 increments the iteration index from i to i+1 and returns to step S703 so that the tuner 20 is set based on the updated CW_{Tuner} and the same cycle of calculating Γ_{FBRX}, estimating Γ_{L,est}, sweeping candidate codewords for relative transducer gain maximization, and updating CW_{Tuner} is repeatedly executed until the stopping criterion is satisfied.

The early-stopping procedure in FIG. 7 provides a bounded repeating behavior by terminating the repeating in response to the stopping criterion being satisfied while maintaining the selection-and-update cycle grounded in acquiring the forward signal and the reverse signal associated with the RFFE 10 and in setting the tuner 20 based on the tuner codeword CW_{Tuner}, as previously described. Details of calculating Γ_{FBRx}, estimating Γ_{L,est}, and selecting the best codeword by maximizing relative transducer gain have been previously described with reference to FIG. 2 and FIG. 3, and therefore are not repeated herein.

After the repeating is terminated in response to the stopping criterion being satisfied, the tuner controller 15 continues to observe feedback associated with the tuner 20 while the tuner 20 is set based on a current tuner codeword. In this operation, the tuner controller 15 can continue acquiring the forward signal and the reverse signal associated with the RFFE 10 and deriving the feedback-receiver reflection value Γ_{FBRx}, and the tuner controller 15 can further estimate the antenna reflection value Γ_{L,est} by applying Γ_{FBRx} and calibration data to the estimation function, as previously described. The tuner controller 15 evaluates whether a performance satisfies a predefined performance criterion based on at least one reflection-related quantity or at least one relative-transducer-gain-related quantity derived from Γ_{FBRx}, Γ_{L,est}, or both. The predefined performance criterion can be stored in the memory 15b as configuration data.

The predefined performance criterion defines whether a current tuner setting provides an acceptable tuning condition under a current transmit condition. The tuner controller 15 can determine whether the performance satisfies the predefined performance criterion based on at least one measurable quantity derived from the forward signal, the reverse signal, Γ_{FBRx}, Γ_{L,est}, or a combination thereof. For example, the tuner controller 15 can determine that the performance satisfies the predefined performance criterion in response to a relative transducer gain associated with the current tuner codeword being greater than or equal to a predefined relative-transducer-gain threshold. The tuner controller 15 can determine that the performance does not satisfy the predefined performance criterion in response to the relative transducer gain being less than the predefined relative-transducer-gain threshold. In another example, the tuner controller 15 can determine whether the performance satisfies the predefined performance criterion based on a reflection-related quantity derived from Γ_{L,est}, such as determining whether |Γ_{L,est}| is less than or equal to a predefined reflection-magnitude threshold, or determining whether a voltage standing wave ratio (VSWR) computed based on Γ_{L,est} is less than or equal to a predefined voltage-standing-wave-ratio threshold. The predefined performance criterion can include one threshold or a plurality of thresholds, and each threshold can be stored in the memory 15b, configured as a parameter of the tuner controller 15, or provided by control logic of the antenna system 100.

In response to detecting that the performance does not satisfy the predefined performance criterion, the tuner controller 15 initiates another plurality of iterations by initializing the tuner codeword with an initial codeword and repeating the selection-and-update cycle, as previously described. The initial codeword can be a fixed initial codeword stored in the memory 15b, or the initial codeword can be selected from a plurality of candidate initial codewords stored in the memory 15b based on a detected use scenario.

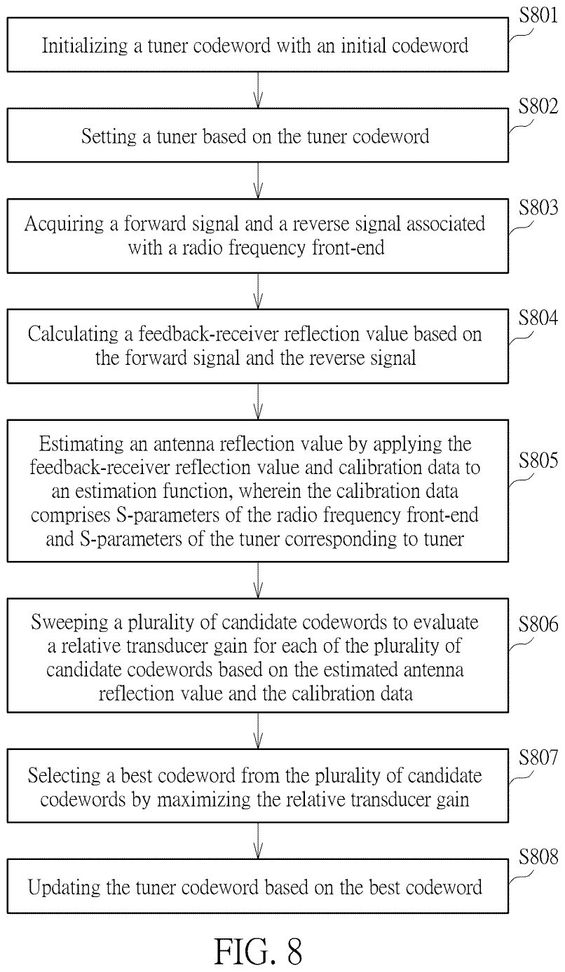

FIG. 8 is a flowchart of a method for performing closed-loop antenna tuning of a tuner controller 15 of the antenna system 100. The method includes steps S801 to S808. Any hardware or technology modification falls into the scope of the present invention. Steps S801 to S808 are illustrated below.
step S801: initializing a tuner codeword with an initial codeword;
step S802: setting a tuner based on the tuner codeword;
step S803: acquiring a forward signal and a reverse signal associated with a radio frequency front-end;
step S804: calculating a feedback-receiver reflection value based on the forward signal and the reverse signal;
step S805: estimating an antenna reflection value by applying the feedback-receiver reflection value and calibration data to an estimation function, wherein the calibration data comprises S-parameters of the radio frequency front-end and S-parameters of the tuner corresponding to tuner codewords;
step S806: sweeping a plurality of candidate codewords to evaluate a relative transducer gain for each of the plurality of candidate codewords based on the estimated antenna reflection value and the calibration data;
step S807: selecting a best codeword from the plurality of candidate codewords by maximizing the relative transducer gain;
step S808: updating the tuner codeword based on the best codeword.

Details of steps S801 to S808 have been previously described, and therefore are not repeated herein. By executing steps S801 to S808, the tuner controller 15 of the antenna system 100 can adapt a tuner setting of the tuner 20 to a current transmit condition while grounding the adaptation on measured forward and reverse signals and calibration data stored in the memory 15b. The tuner controller 15 derives the feedback-receiver reflection value and estimates the antenna-side reflection value, and the tuner controller 15 then evaluates relative transducer gain values across candidate codewords under the estimated antenna reflection value and corresponding S-parameters. The selection-and-update cycle updates the tuner codeword so that a subsequent setting of the tuner 20 reflects a codeword associated with a higher relative transducer gain under the current condition. Repeating the cycle across iterations can reduce sensitivity to an initial codeword and can improve consistency of tuner codeword selection across varying use scenarios. Accordingly, the antenna system 100 can maintain antenna tuning behavior that tracks changes in impedance and reflection during runtime operation.

In summary, a tuner controller can perform closed-loop antenna tuning by setting a tuner based on a tuner codeword, acquiring a forward signal and a reverse signal associated with a radio frequency front-end, deriving a feedback-receiver reflection value based on the forward signal and the reverse signal, and estimating an antenna reflection value by applying the feedback-receiver reflection value and calibration data to an estimation function. The tuner controller can evaluate a relative transducer gain for each of a plurality of candidate codewords based on the estimated antenna reflection value and corresponding calibration data, select a best codeword by maximizing the relative transducer gain, and update the tuner codeword based on the best codeword so that a subsequent tuner setting reflects a selected codeword under a current transmit condition. The selection-and-update cycle can be executed iteratively, and the iterations can be controlled by continuing without termination, by terminating after reaching a predefined maximum iteration count, or by terminating in response to a stopping criterion being satisfied, thereby providing a practical and adaptable tuning mechanism for runtime operation under varying use scenarios.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method for performing closed-loop antenna tuning, the method comprising:
initializing a tuner codeword with an initial codeword;
setting a tuner based on the tuner codeword;
acquiring a forward signal and a reverse signal associated with a radio frequency front-end;
calculating a feedback-receiver reflection value based on the forward signal and the reverse signal;
estimating an antenna reflection value by applying the feedback-receiver reflection value and calibration data to an estimation function, wherein the calibration data comprises S-parameters of the radio frequency front-end and S-parameters of the tuner corresponding to tuner codewords;
sweeping a plurality of candidate codewords to evaluate a relative transducer gain for each of the plurality of candidate codewords based on the estimated antenna reflection value and the calibration data;
selecting a best codeword from the plurality of candidate codewords by maximizing the relative transducer gain; and
updating the tuner codeword based on the best codeword.

2. The method of claim 1, further comprising:
repeating setting, acquiring, calculating, estimating, sweeping, selecting, and updating for a plurality of iterations, wherein the tuner codeword updated based on the best codeword in a preceding iteration is used as the tuner codeword for a subsequent iteration.

3. The method of claim 2, further comprising:
terminating the repeating in response to an iteration count reaching a predefined maximum iteration count.

4. The method of claim 2, further comprising:
terminating the repeating in response to a stopping criterion being satisfied.

5. The method of claim 4, wherein the stopping criterion is satisfied in response to the best codeword being identical to the tuner codeword.

6. The method of claim 4, wherein the stopping criterion is satisfied in response to an improvement in the relative transducer gain between a preceding iteration and a current iteration being less than or equal to a predefined threshold.

7. The method of claim 2, wherein the repeating is performed without terminating in response to an iteration count reaching a predefined maximum iteration count and without terminating in response to a stopping criterion being satisfied.

8. The method of claim 2, further comprising:
after the repeating is terminated, continuing to observe feedback associated with the tuner while the tuner is set based on the tuner codeword; and
in response to detecting that a performance does not satisfy a predefined performance criterion, initiating another plurality of iterations by repeating the setting, acquiring, calculating, estimating, sweeping, selecting, and updating.

9. The method of claim 1, wherein the calibration data is stored in a memory of a tuner controller, and estimating the antenna reflection value comprises acquiring, by a processor of the tuner controller, the calibration data from the memory.

10. The method of claim 1, wherein initializing the tuner codeword with the initial codeword comprises selecting the initial codeword from a plurality of candidate initial codewords based on a detected use scenario, and the plurality of candidate initial codewords is stored in a memory.

11. A tuner controller for performing closed-loop antenna tuning, the tuner controller comprising:
a processor; and
a memory coupled to the processor and storing calibration data;
wherein the processor is configured to:
initialize a tuner codeword with an initial codeword;
set a tuner based on the tuner codeword;
acquire a forward signal and a reverse signal associated with a radio frequency front-end;
calculate a feedback-receiver reflection value based on the forward signal and the reverse signal;
estimate an antenna reflection value by applying the feedback-receiver reflection value and the calibration data to an estimation function, wherein the calibration data comprises S-parameters of the radio frequency front-end and S-parameters of the tuner corresponding to tuner codewords;
sweep a plurality of candidate codewords to evaluate a relative transducer gain for each of the plurality of candidate codewords based on the estimated antenna reflection value and the calibration data;
select a best codeword from the plurality of candidate codewords by maximizing the relative transducer gain; and
update the tuner codeword based on the best codeword.

12. The tuner controller of claim 11, wherein the processor is further configured to:
repeat setting, acquiring, calculating, estimating, sweeping, selecting, and updating for a plurality of iterations, wherein the tuner codeword updated based on the best codeword in a preceding iteration is used as the tuner codeword for a subsequent iteration.

13. The tuner controller of claim 12, wherein the processor is further configured to maintain an iteration count and terminate the repeating in response to the iteration count reaching a predefined maximum iteration count.

14. The tuner controller of claim 12, wherein the processor is further configured to terminate the repeating in response to a stopping criterion being satisfied.

15. The tuner controller of claim 14, wherein the stopping criterion is satisfied in response to the best codeword being identical to the tuner codeword.

16. The tuner controller of claim 14, wherein the stopping criterion is satisfied in response to an improvement in the relative transducer gain between a preceding iteration and a current iteration being less than or equal to a predefined threshold.

17. The tuner controller of claim 12, wherein the processor is further configured to perform the repeating without terminating in response to an iteration count reaching a predefined maximum iteration count and without terminating in response to a stopping criterion being satisfied.

18. The tuner controller of claim 12, wherein the processor is further configured to:
after the repeating is terminated, continue to observe feedback associated with the tuner while the tuner is set based on the tuner codeword; and
in response to detecting that a performance does not satisfy a predefined performance criterion, initiate another plurality of iterations by repeating setting, acquiring, calculating, estimating, sweeping, selecting, and updating.

19. The tuner controller of claim 11, wherein the processor is further configured to acquire the calibration data from the memory, and apply the feedback-receiver reflection value and the calibration data acquired from the memory to the estimation function.

20. The tuner controller of claim 11, wherein the memory further stores a plurality of candidate initial codewords, and the processor is further configured to detect a use scenario and select the initial codeword from the plurality of candidate initial codewords based on the detected use scenario.
